(19) United States
(12) Patent Application Publication
(10) Pub. No.: US 2023/0201810 A1
(43) Pub. Date: Jun. 29, 2023

(54) Nitride Semiconductor Photocatalytic Thin Film and Method for Manufacturing Nitride Semiconductor Photocatalytic Thin Film

(71) Applicant: Nippon Telegraph and Telephone Corporation, Tokyo (JP)

(72) Inventors: Yuya Uzumaki, Musashino-shi, Tokyo (JP); Sayumi Sato, Musashino-shi, Tokyo (JP); Yoko Ono, Musashino-shi, Tokyo (JP); Takeshi Komatsu, Musashino-shi, Tokyo (JP)

(21) Appl. No.: 17/923,513

(22) PCT Filed: May 25, 2020
(86) PCT No.: PCT/JP2020/020505

§ 371 Date: Nov. 4, 2022

(51) Int. Cl. B01J 27/24; B01J 35/02; B01J 35/00

(52) U.S. Cl. CPC B01J 27/24; B01J 35/02; B01J 35/004

(57) ABSTRACT

The nitride semiconductor photocatalytic thin film of the present embodiment is a nitride semiconductor photocatalytic thin film that exhibits a catalytic function to cause a redox reaction by light irradiation. The nitride semiconductor photocatalytic thin film includes: a conductive substrate; a semiconductor thin film disposed on a surface of the conductive substrate; a first catalyst layer that forms an ohmic junction on a portion of a surface of the semiconductor thin film; a second catalyst layer that forms a Schottky junction on a portion of the surface of the semiconductor thin film, and a protective layer disposed to cover a back surface of the conductive substrate and side surfaces of the conductive substrate and the semiconductor thin film. The substrate and the semiconductor thin film include a same element and have a same crystal structure.

### TECHNICAL FIELD

The present disclosure relates to a nitride semiconductor photocatalytic thin film and a method for producing the nitride semiconductor photocatalytic thin film.

### BACKGROUND ART

The decomposition reaction of water using a photocatalyst consists of an oxidation reaction of water and a reduction reaction of protons.

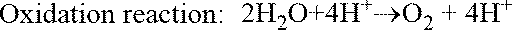

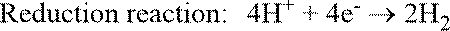

When the n-type photocatalic material is irradiated with light, electrons and holes are produced and separated in the photocatalyst. The holes migrate to the surface of the photocatalytic material and contribute to a reduction reaction of protons. On the other hand, the electrons move to the reduction electrode and contribute to the reduction reaction of protons. Ideally, such a redox reaction proceeds and a water splitting reaction occurs.

A water splitting apparatus in the related art includes an oxidation tank and a reduction tank connected through a proton exchange membrane, an aqueous solution and an oxidation electrode are placed in the oxidation tank, and an aqueous solution and a reduction electrode are placed in the reduction tank. The oxidation and reduction electrodes are electrically connected by conductors. The oxidation electrode is, for example, a nitride semiconductor, titanium oxide, or amorphous silicon. The reduction electrode is a metal or a metal compound such as nickel, iron, gold, platinum, silver, copper, indium, or titanium. Light having a wavelength that can be absorbed by the material forming the oxidation electrode is irradiated from a light source to cause a water splitting reaction. For example, when the oxidation electrode is composed of gallium nitride, the wavelength that can be absorbed is 365 nm or less. The light source is, for example, a xenon lamp, a mercury lamp, a halogen lamp, a simulated solar source, sunlight, or a combination thereof.

### CITATION LIST

### Non Patent Literature

NPL 1: S. Yotsuhashi, et al., “CO2 Conversion with Light and Water by GaN Photoelectrode”; Japanese Journal of Applied Physics, 51 (2012) 02BP07
NPL 2: S.Y. Reece, et al., “Wires Solar Water Splitting Using Silicone-Based Semiconductors and Earth-Abundant Catalysts”, Science, 2011, Volume 334, pp. 645-648

### SUMMARY OF THE INVENTION

### Technical Problem

Since the water splitting apparatus described above has many components and its reaction system is complicated, it is desired to make a reaction system simpler and smaller than ever before. For example, using an apparatus in which a photocatalytic thin film and an aqueous solution are placed in a photocatalyst tank, light is irradiated from a light source to the photocatalytic thin film in the aqueous solution to cause a water splitting reaction. The photocatalytic thin film is, like an oxidation electrode, a nitride semiconductor, titanium oxide, or amorphous silicon. A metal auxiliary catalyst that promotes a water splitting reaction is supported on a surface of the photocatalytic thin film. This apparatus has a simple reaction system, and it is expected to reduce the cost and size of the system.

However, The light energy conversion efficiency of the photocatalytic thin film decreases with the light irradiation time even in the apparatus with the simple configuration.

For example, a gallium nitride thin film grown on a sapphire substrate is used as a photocatalytic thin film. When a gallium nitride thin film is irradiated with light in an aqueous solution, the etching reaction of GaN proceeds on the gallium nitride surface as a side reaction in addition to the desired water oxidation reaction.

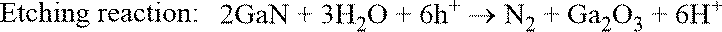

As the etching reaction proceeds and the reaction field where the target reaction can proceed decreases, the solar energy conversion efficiency decreases in a few hours.

The present disclosure has been made in view of the above, and an object of the present invention is to prolong the solar energy conversion efficiency of semiconductor photocatalytic thin films.

### Means for Solving the Problem

The nitride semiconductor photocatalytic thin film according to an aspect of the present disclosure is a nitride semiconductor photocatalytic thin film that exhibits a catalytic function to cause a redox reaction by light irradiation. The nitride semiconductor photocatalytic thin film includes a conductive substrate; a semiconductor thin film disposed on a surface of the substrate; a first catalyst layer that forms an ohmic junction on a portion of a surface of the semiconductor thin film; a second catalyst layer that forms a Schottky junction on a portion of the surface of the semiconductor thin film; and a protective layer disposed to cover a back surface of the substrate and side surfaces of the substrate and the semiconductor thin film. The substrate and the semiconductor thin film include a same element and have a same crystal structure.

A method for producing a nitride semiconductor photocatalytic thin film according to an aspect of the present disclosure is a method for producing a nitride semiconductor photocatalytic thin film that exhibits a catalytic function to cause a redox reaction by light irradiation. The method includes: forming a semiconductor thin film on a surface of a conductive substrate; forming a first catalyst layer on a portion of a surface of the semiconductor thin film; performing heat-treatment to form an ohmic junction between the semiconductor thin film and the first catalyst layer; forming a second catalyst layer on a portion of the surface of the semiconductor thin film; performing heat-treatment to the second catalyst layer; and forming a protective layer to cover a back surface of the substrate and side surfaces of the substrate and the semiconductor thin film. The substrate and the semiconductor thin film include a same element and have a same crystal structure.

### Effects of the Invention

The present disclosure makes it possible to extend the solar energy conversion efficiency of the semiconductor photocatalytic thin film.

### BRIEF DESCRIPTION OF DRAWINGS

FIG. 1 is a cross-sectional view illustrating a configuration of a nitride semiconductor photocatalytic thin film according to an embodiment of the present disclosure.

FIG. 2 is a diagram illustrating a first catalyst layer and a second catalyst layer dispersed on a surface of the nitride semiconductor photocatalytic thin film.

FIG. 3 is a cross-sectional view illustrating a configuration of another nitride semiconductor photocatalytic thin film according to the present embodiment.

FIG. 4 is a flowchart illustrating a method for producing the nitride semiconductor photocatalytic thin film in FIG. 1.

FIG. 5 is a flowchart illustrating a method for producing the nitride semiconductor photocatalytic thin film in FIG. 3.

FIG. 6 illustrates an overview of an apparatus for performing a redox reaction test.

### DESCRIPTION OF EMBODIMENTS

An embodiment of the present disclosure will be described below with reference to the drawings. The present disclosure is not limited to the embodiments described below, and changes may be made without departing from the spirit of the present invention.

### Configuration of Nitride Semiconductor Photocatalytic Thin Film

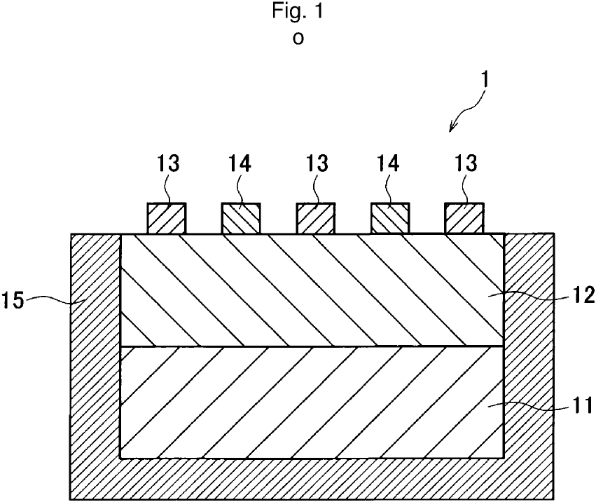

FIG. 1 is a cross-sectional view illustrating an example of a configuration of a nitride semiconductor photocatalytic thin film according to the present embodiment. The nitride semiconductor photocatalytic thin film in FIG. 1 exhibits a catalytic function to cause a redox reaction by light irradiation in an aqueous solution.

The nitride semiconductor photocatalytic thin film 1 illustrated in FIG. 1 includes a conductive substrate 11, a semiconductor thin film 12 disposed on a surface of the substrate 11, a first catalyst layer 13 that forms an ohmic junction on a portion of a surface of the semiconductor thin film 12, a second catalyst layer 14 that forms a Schottky junction on a portion of the surface of the semiconductor thin film 12, and a protective layer 15 formed to cover a back surface of the substrate 11 and side surfaces of the substrate 11 and the semiconductor thin film 12.

The substrate 11 and the semiconductor thin film 12 include the same element and have the same crystal structure. For example, the substrate 11 and the semiconductor thin film 12 are III-V compound semiconductors such as gallium nitride (GaN), aluminum gallium nitride (AlGaN), or indium gallium nitride (InGaN). The semiconductor thin film 12 has a photocatalytic function that causes a reaction of a substance to be reacted by light irradiation.

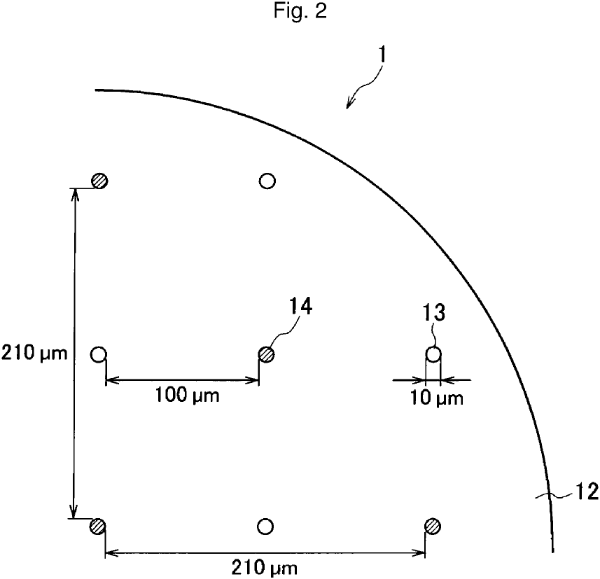

The first catalyst layer 13 and the second catalyst layer 14 are made of materials that have an auxiliary catalytic function for the semiconductor thin film 12 and are dispersed on the semiconductor thin film 12. Specifically, as illustrated in FIG. 2, the first catalyst layer 13 has a disk shape with a diameter of 10 µm and dispersed at 210 µm intervals. The second catalyst layer 14 has a disk shape with a diameter of 10 µm and is dispersed with a distance from 100 µm from the first catalyst layer 13. The first catalyst layer 13 is an auxiliary catalyst for a reduction reaction. The second catalyst layer 14 is an auxiliary catalyst for oxidation reaction and may be at least one metal selected from the group consisting of Ni, Co, Cu, W, Ta, Pd, Ru, Fe, Zn, and Nb, or an oxide including a metal. The film thickness of the second catalyst layer 14 is preferably from 1 nm to 10 nm, and more preferably from 1 nm to 3 nm so as to sufficiently transmit light. The second catalyst layer 14 may entirely cover an exposed surface of the semiconductor thin film 12.

The protective layer 15 prevents the substrate 11 and the semiconductor thin film 12 from degradation due to contact with the aqueous solution. The protective layer 15 includes an insulative material such as an epoxy resin that has not reaction with an aqueous solution, the substrate 11, and the semiconductor thin film 12.

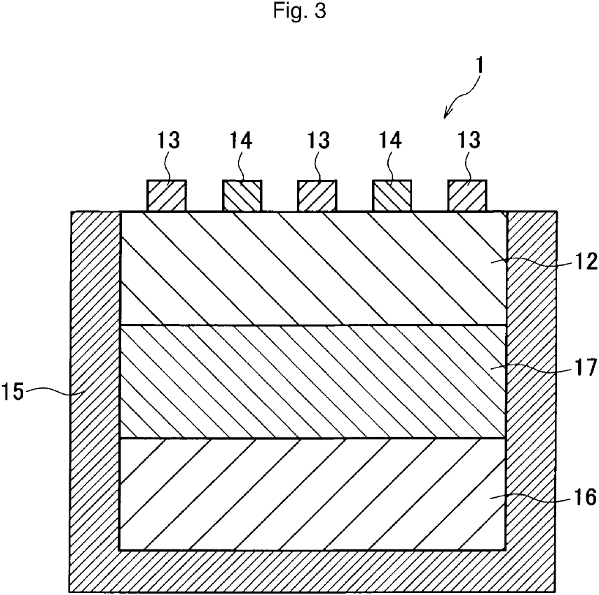

FIG. 3 is a cross-sectional view illustrating an example of another configuration of a nitride semiconductor photocatalytic thin film according to the present embodiment. The nitride semiconductor photocatalytic thin film in FIG. 3 exhibits catalytic function to cause a redox reaction by light irradiation in an aqueous solution.

The nitride semiconductor photocatalytic thin film 1 illustrated in FIG. 3 includes a conductive substrate 16, an n-type semiconductor thin film 17 disposed on a surface of the substrate 16, a semiconductor thin film 12 disposed on a surface of the semiconductor thin film 17, a first catalyst layer 13 that forms an ohmic junction on a portion of a surface of the semiconductor thin film 12, a second catalyst layer 14 that forms a Schottky junction on a portion of the surface of the semiconductor thin film 12, and a protective layer 15 formed to cover a back surface of the substrate 11 and aside surfaces of the substrate 11 and the semiconductor thin films 12 and 17.

The substrate 16, the semiconductor thin film 17, and the semiconductor thin film 12 include the same element and have the same crystal structure. For example, the substrate 16, the semiconductor thin film 17, and the semiconductor thin film 12 are III-V compound semiconductors such as gallium nitride (GaN), aluminum gallium nitride (AlGaN), or indium gallium nitride (InGaN). The semiconductor thin film 12 has a photocatalytic function that causes a reaction of a substance to be reacted by light irradiation.

The first catalyst layer 13, the second catalyst layer 14, and the protective layer 15 are the same as the nitride semiconductor photocatalytic thin film in FIG. 1.

### Method for Producing Nitride Semiconductor Photocatalytic Thin Film

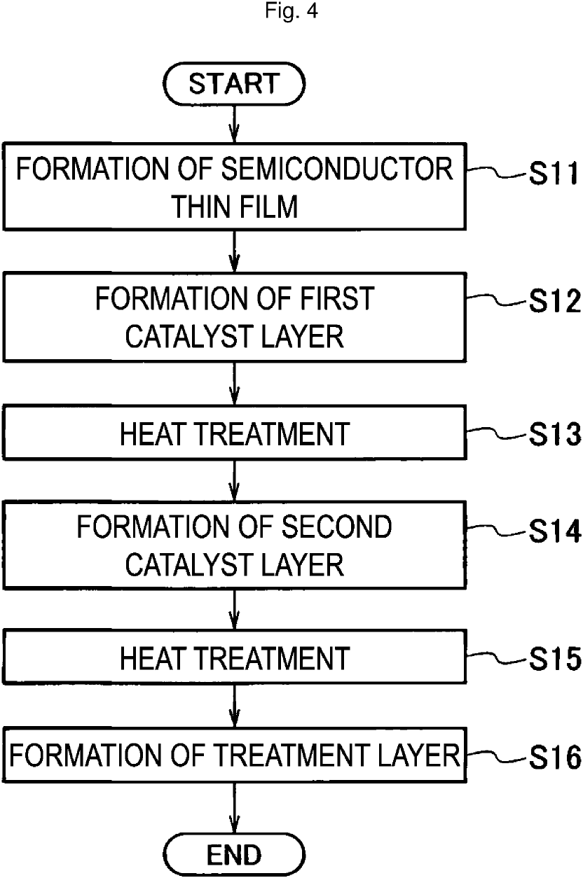

The method for producing the nitride semiconductor photocatalytic thin film in FIG. 1 is described with reference to FIG. 4.

In step S11, the semiconductor thin film 12 including a III-V compound semiconductor is formed on the conductive substrate 11 including a III-V compound semiconductor.

In step S12, the first catalyst layer 13 is formed on a portion of a top surface of the semiconductor thin film 12.

In step S13, the nitride semiconductor on which the first catalyst layer 13 is formed is heat-treated to form an ohmic junction at an interface between the semiconductor thin film 12 and the first catalyst layer 13.

In step S14, the second catalyst layer 14 is formed on a portion of the top surface of the semiconductor thin film 12.

In step S15, the nitride semiconductor on which the second catalyst layer 14 is formed is heat-treated. This heat treatment step may be performed on a hot plate or heat treated in an electric furnace.

In step S16, the protective layer 15 is formed to cover surfaces other than the top surface of the semiconductor thin film 12 on which the first catalyst layer 13 and the second catalyst layers 14 are formed.

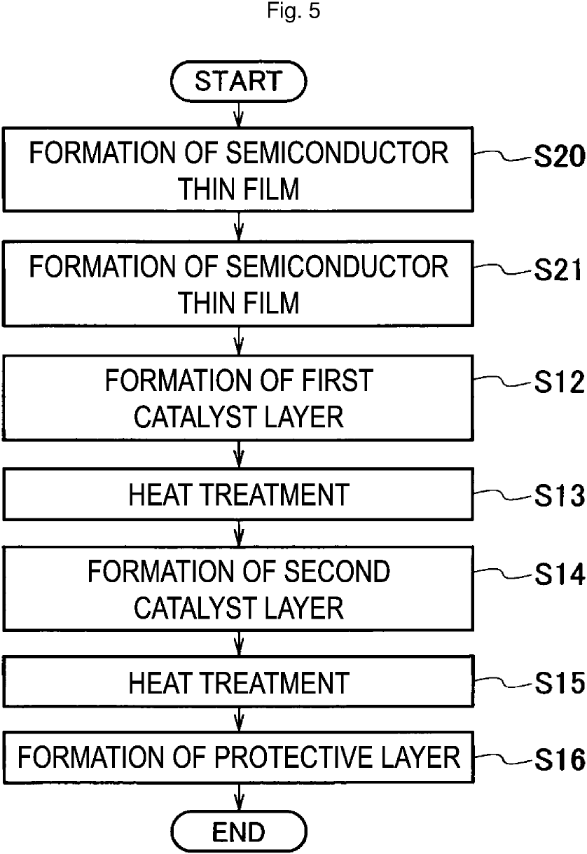

Next, a method for producing the nitride semiconductor photocatalytic thin film in FIG. 3 is described with reference to FIG. 5.

In step S20, the semiconductor thin film 17 including a III-V compound semiconductor is formed on the insulative substrate 16 including a III-V compound semiconductor.

In step S21, the semiconductor thin film 12 including a III-V compound semiconductor is formed on the semiconductor thin film 17.

Thereafter, the first catalyst layer 13, the second catalyst layer 14, and the protective layer 15 are formed in the same manner as the processes from step S12 to step S16 in FIG. 4.

### Example of Nitride Semiconductor Photocatalytic Thin Film

The redox reaction test described below was performed using Examples 1 to 3 in which the semiconductor thin film 12 of the nitride semiconductor photocatalytic thin film in FIG. 1 has been changed, and Examples 4 and 5 in which the semiconductor thin film 12 of the nitride semiconductor photocatalytic thin film in FIG. 2 has been changed.

### Example 1

Example 1 is a nitride semiconductor photocatalytic thin film with the configuration illustrated in FIG. 1.

In step S11, a GaN semiconductor thin film was epitaxially grown on an n-GaN substrate by a metal-organic chemical vapor deposition (MOCVD) method to form the semiconductor thin film 12 as a light-absorbing layer (a layer that absorbs light and generates electrons and holes) on the substrate 11. Ammonia gas and trimethylgallium were used as growth materials. Hydrogen was used as a carrier gas to be fed into a growth furnace. The film thickness of the semiconductor thin film 12 was set to 100 nm, which is sufficient to absorb light. The nitride semiconductor was then cleaved into 1 cm × 1 cm pieces for testing.

In step S12, as illustrated in FIG. 2, the first catalyst layer 13 was formed on the surface of the semiconductor thin film 12 by vacuum depositing metal (Ti, Al, Ti, and Pt) having a disk shape with a diameter of 10 µm at intervals of 210 µm. Here, Ti with a thicknesses of 25 nm, Al with a thickness of 50 nm, Ti with a thickness of 25 nm, and Pt with a thickness of 100 nm were layered in this order from the semiconductor thin film side.

In step S13, the nitride semiconductor having the first catalyst layer 13 was heat-treated in a nitrogen atmosphere at 800° C. for 30 seconds. By the heat treatment, a pseudo ohmic junction was formed at the interface of the semiconductor thin film 12 with the first catalyst layer 13.

In step S14, as illustrated in FIG. 2, disk-shaped Ni with a diameter of 10 µm was vacuum deposited on the surface of the semiconductor thin film 12 with a distance of 100 µm from the first catalyst layer 13 to form a Schottky junction between the semiconductor thin film 12 and Ni.

In step S15, NiO was formed through heat treatment performed in air at 300° C. for one hour on the nitride semiconductor in which Ni was vacuum-deposited Ni to obtain the second catalyst layer 14. When the cross section of the sample was observed with a transmission electron microscope (TEM), the film thickness of the NiO thin film was 2 nm.

In step S16, the protective layer 15 was formed using an epoxy resin to cover a back surface of the substrate 11 (a surface on which the semiconductor thin film 12 was not formed) and side surfaces of the substrate 11 and the semiconductor thin film 12.

The nitride semiconductor photocatalytic thin film of Example 1 was obtained in such a manner.

### Example 2

Example 2 is a nitride semiconductor photocatalytic thin film with the configuration illustrated in FIG. 1.

In step S11, an InGaN semiconductor thin film with an indium composition ratio of 1% was epitaxially grown on an n-GaN substrate by MOCVD to form the semiconductor thin film 12 on the substrate 11. Ammonia gas, trimethylgallium, and trimethylindium were used as growth materials. Hydrogen was used as a carrier gas to be fed into a growth furnace. The film thickness of the semiconductor thin film 12 was set to 100 nm, which is sufficient to absorb light.

Thereafter, the first catalyst layer 13, the second catalyst layer 14, and the protective layer 15 were formed through the steps after step S12 in Example 1 to obtain the nitride semiconductor photocatalytic thin film of Example 2.

### Example 3

Example 3 is a nitride semiconductor photocatalytic thin film with the configuration illustrated in FIG. 1.

In step S11, an AlGaN semiconductor thin film with an aluminum composition of 5% was epitaxially grown on an n-GaN substrate by MOCVD to form the semiconductor thin film 12 on the substrate 11. Ammonia gas, trimethylgallium, and trimethylaluminum were used as growth materials. Hydrogen was used as a carrier gas to be fed into a growth furnace. The film thickness of the semiconductor thin film 12 was set to 100 nm, which is sufficient to absorb light.

Thereafter, the first catalyst layer 13, the second catalyst layer 14, and the protective layer 15 were formed through the steps after step S12 in Example 1 to obtain the nitride semiconductor photocatalytic thin film of Example 3.

### Example 4

Example 4 is a nitride semiconductor photocatalytic thin film with the configuration illustrated in FIG. 2.

In step S20, a silicon doped n-GaN semiconductor thin film was epitaxially grown on a GaN substrate by MOCVD to form the electronically conductive semiconductor thin film 17 on the substrate 16. Ammonia gas and trimethylgallium were used as growth materials. Silane gas was used as an n-type impurity source. Hydrogen was used as a carrier gas to be fed into a growth furnace. The film thickness of the n-GaN semiconductor thin film was 2 µm. The carrier density was 3 × 10¹⁸ cm⁻³.

In step S21, an InGaN semiconductor thin film with an indium composition ratio of 1% was epitaxially grown on the n-GaN semiconductor thin film by MOCVD to form the semiconductor thin film 12 as a light-absorbing layer on the semiconductor thin film 17. Ammonia gas, trimethylgallium, and trimethylindium were used as growth materials. Hydrogen was used as a carrier gas to be fed into a growth furnace. The film thickness of the semiconductor thin film 12 was set to 100 nm, which is sufficient to absorb light.

Thereafter, the first catalyst layer 13, the second catalyst layer 14, and the protective layer 15 were formed through the steps after step S12 in Example 1 to obtain the nitride semiconductor photocatalytic thin film of Example 4.

### Example 5

Example 5 is a nitride semiconductor photocatalytic thin film with the configuration illustrated in FIG. 2.

In step S20, a silicon doped n-GaN semiconductor thin film was epitaxially grown on a GaN substrate by MOCVD to form the electronically conductive semiconductor thin film 17 on the substrate 16. Ammonia gas and trimethylgallium were used as growth materials. Silane gas was used as an n-type impurity source. Hydrogen was used as a carrier gas to be fed into a growth furnace. The film thickness of the n-GaN semiconductor thin film was 2 µm. The carrier density was 3 × 10¹⁸ cm⁻³.

In step S21, an AlGaN semiconductor thin film with an aluminum composition of 5% was epitaxially grown on the n-GaN semiconductor thin film by MOCVD to form the semiconductor thin film 12 as a light-absorbing layer on the semiconductor thin film 17. Ammonia gas, trimethylgallium, and trimethylaluminum were used as growth materials. Hydrogen was used as a carrier gas to be fed into a growth furnace. The film thickness of the semiconductor thin film 12 was set to 100 nm, which is sufficient to absorb light.

Thereafter, the first catalyst layer 13, the second catalyst layer 14, and the protective layer 15 were formed thought the steps after step S12 in Example 1 to obtain the nitride semiconductor photocatalytic thin film of Example 5.

### Comparative Example

The redox reaction test described below was carried out using Comparative Examples 1 to 10 in which the material of the substrate 11 of Examples 1 to 5 was changed and Comparative Examples 11 and 12 in which no protective layer 15 of Examples 1 and 4 was formed.

### Comparative Example 1

Comparative Example 1 differs from Example 1 in that an n-Si substrate was used as the substrate 11. Other procedures are the same as those in Example 1.

### Comparative Example 2

Comparative Example 2 differs from Example 2 in that an n-Si substrate was used as the substrate 11. Other procedures are the same as those in Example 2.

### Comparative Example 3

Comparative Example 3 differs from Example 3 in that an n-Si substrate was used as the substrate 11. Other procedures are the same as those in Example 3.

### Comparative Example 4

Comparative Example 1 differs from Example 1 in that a SiC substrate was used as the substrate 11. Other procedures are the same as those in Example 1.

### Comparative Example 5

Comparative Example 5 differs from Example 2 in that a SiC substrate was used as the substrate 11. Other procedures are the same as those in Example 2.

### Comparative Example 6

Comparative Example 6 differs from Example 3 in that a SiC substrate was used as the substrate 11. Other procedures are the same as those in Example 3.

### Comparative Example 7

Comparative Example 7 differs from Example 4 in that a sapphire substrate was used as the substrate 11. Other procedures are the same as those in Example 4.

### Comparative Example 8

Comparative Example 8 differs from Example 5 in that a sapphire substrate was used as the substrate 11. Other procedures are the same as those in Example 5.

### Comparative Example 9

Comparative Example 9 differs from Example 4 in that a Si substrate was used as the substrate 11. Other procedures are the same as those in Example 4.

### Comparative Example 10

Comparative Example 10 differs from Example 5 in that a Si substrate was used as the substrate 11. Other procedures are the same as those in Example 5.

### Comparative Example 11

Comparative Example 11 differs from Example 1 in that a nitride semiconductor photocatalytic thin film without the protective layer 15 was used. Other procedures are the same as those in Example 1.

### Comparative Example 12

Comparative Example 11 differs from Example 4 in that a nitride semiconductor photocatalytic thin film without the protective layer 15 was used. Other procedures are the same as those in Example 4.

### Redox Reaction Test

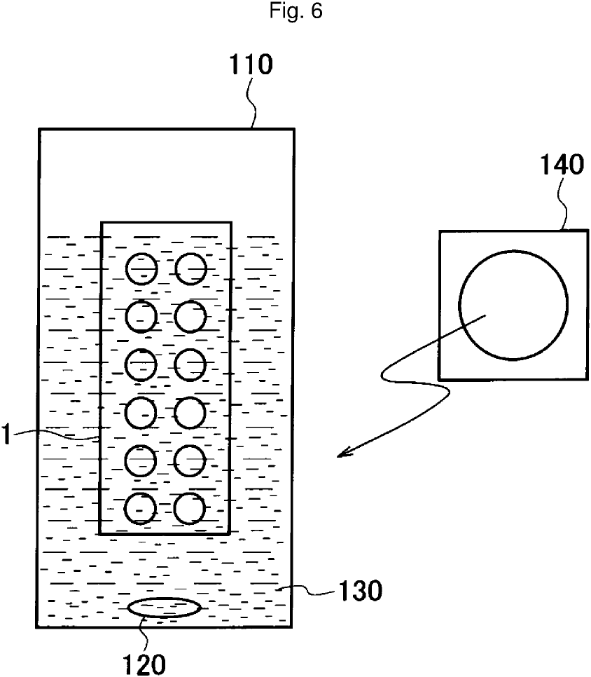

Redox reaction tests were performed for Examples 1 to 5 and Comparative Examples 1 to 12 using the apparatus illustrated in FIG. 6.

A reaction cell with a quartz window with a capacity of 150 ml was used as a photocatalyst tank 110, and a stirring bar 120 and an aqueous solution 130 were placed in a photocatalyst tank 110. For the aqueous solution 130, 125 ml of 1 mol/l potassium hydroxide solution was used.

The semiconductor photocatalytic thin films of Examples 1 to 5 and Comparative Examples 1 to 12 were immersed in the aqueous solution 130 and fixed so that the surface of the semiconductor thin film 12 having the first catalyst layer 13 and the second catalyst layer 14 faced a light source 140.

Nitrogen gas was bubbled at 200 ml/min for 30 minutes to complete defoaming and replacement with air, and then sealed with a silicon Teflon septum. The pressure inside the photocatalyst tank 110 was set to atmospheric pressure (1 atm).

A 300 W high-pressure xenon lamp (the wavelength of 400 nm or more was cut, and irradiance was 5 mW/cm²) was used for the light source 140. The light from the light source 140 was uniformly irradiated to the semiconductor photocatalytic thin film from outside the quartz window of the photocatalyst tank 110.

The light-irradiated area of the sample was set to 1 cm², and the aqueous solution 130 was stirred at a rotational speed of 250 rpm at the center position of the bottom of the photocatalyst tank 110 using the stirring bar 120 and a stirrer.

At a certain time after light irradiation, a gas from the photocatalyst tank 110 was collected with a syringe from the septum section, and reaction products were analyzed with a gas chromatograph mass spectrometer. As a result, the generation of hydrogen and oxygen was confirmed.

### Test Results

Table 1 shows the generated amounts of oxygen and hydrogen gases with respect to the light irradiation time in Examples 1 to 5 and Comparative Examples 1 to 12. The generated amount of each gas was normalized by the surface area of the semiconductor photoelectrode.

TABLE 1

| Sample | Substrate | Semiconductor thin film 12 | Semiconductor thin film 17 | Amount of gas generated in cell / µmol·cm⁻²·h⁻¹ | | | | | |
|---|---|---|---|---|---|---|---|---|---|
| | | | | Immediately after light irradiation | | 50 hours after light irradiation | | 100 hours after light irradiation | |
| | | | | Oxygen | Hydrogen | Oxygen | Hydrogen | Oxygen | Hydrogen |
| Example 1 | n-GaN | GaN | None | 10 | 21 | 9 | 18 | 8 | 17 |
| Example 2 | n-GaN | InGaN | None | 29 | 60 | 26 | 54 | 22 | 44 |
| Example 3 | n-GaN | AlGaN | None | 13 | 26 | 12 | 23 | 10 | 21 |
| Example 4 | GaN | InGaN | n-GaN | 31 | 63 | 27 | 54 | 21 | 44 |
| Example 5 | GaN | AlGaN | n-GaN | 14 | 30 | 13 | 26 | 10 | 22 |
| Comparative Example 1 | n-Si | GaN | None | 8 | 18 | 4 | 7 | 1 | 3 |
| Comparative Example 2 | n-Si | InGaN | None | 25 | 53 | 10 | 25 | 1 | 4 |
| Comparative Example 3 | n-Si | AlGaN | None | 8 | 16 | 3 | 7 | 1 | 3 |
| Comparative Example 4 | SiC | GaN | None | 10 | 19 | 3 | 8 | 1 | 3 |
| Comparative Example 5 | SiC | InGaN | None | 24 | 50 | 10 | 22 | 1 | 3 |
| Comparative Example 6 | SiC | AlGaN | None | 9 | 17 | 3 | 7 | 1 | 3 |
| Comparative Example 7 | Sapphire | InGaN | n-GaN | 31 | 62 | 20 | 42 | 9 | 24 |
| Comparative Example 8 | Sapphire | AlGaN | n-GaN | 14 | 30 | 11 | 22 | 5 | 14 |
| Comparative Example 9 | Si | InGaN | n-GaN | 29 | 59 | 12 | 27 | 1 | 5 |
| Comparative Example 10 | Si | AlGaN | n-GaN | 15 | 31 | 7 | 16 | 1 | 3 |
| Comparative Example 11 | n-GaN | GaN | None | 10 | 21 | 8 | 16 | 6 | 14 |
| Comparative Example 12 | GaN | InGaN | n-GaN | 31 | 63 | 25 | 51 | 18 | 38 |

In all cases, it was found that oxygen and hydrogen were generated during light irradiation.

The dislocation density of each sample is shown in Table 2. For each sample, X-ray rocking curve (XRC) measurements were performed at the center of the substrate using an X-ray diffractometer, the XRC measurements corresponding to the (002) plane perpendicular to the crystal growth direction. The helix dislocation density was calculated from the obtained half-width using the following equation. Here, β is a half-width, and b is 0.5185 nm.

Helical dislocation density is calculated by dividing β² by 4.35b².

TABLE 2

| | | | | |
|---|---|---|---|---|
| Sample | Substrate | Semiconductor thin film 12 | Semiconductor thin film 17 | Dislocation density/cm⁻² |
| Example 1 | n-GaN | GaN | None | 5.0 × 10⁷ |
| Example 2 | n-GaN | InGaN | None | 5.3 × 10⁷ |
| Example 3 | n-GaN | AlGaN | None | 5.2 × 10⁷ |
| Example 4 | GaN | InGaN | n-GaN | 5.1 × 10⁷ |
| Example 5 | GaN | AlGaN | n-GaN | 4.9 × 10⁷ |
| Comparative Example 1 | n-Si | GaN | None | 4.9 × 10¹⁰ |
| Comparative Example 2 | n-Si | InGaN | None | 4.5 × 10¹⁰ |
| Comparative Example 3 | n-Si | AlGaN | None | 4.7 × 10¹⁰ |
| Comparative Example 4 | SiC | GaN | None | 1.1 × 10¹⁰ |
| Comparative Example 5 | SiC | InGaN | None | 1.5 × 10¹⁰ |
| Comparative Example 6 | SiC | AlGaN | None | 1.2 × 10¹⁰ |
| Comparative Example 7 | Sapphire | InGaN | n-GaN | 4.3 × 10⁸ |
| Comparative Example 8 | Sapphire | AlGaN | n-GaN | 3.2 × 10⁸ |
| Comparative Example 9 | Si | InGaN | n-GaN | 4.1 × 10¹⁰ |
| Comparative Example 10 | Si | AlGaN | n-GaN | 4.3 × 10¹⁰ |
| Comparative Example 11 | n-GaN | GaN | None | 5.0 × 10⁷ |
| Comparative Example 12 | GaN | InGaN | n-GaN | 5.1 × 10⁷ |

It was found that changing the substrate type changes the dislocation density. The dislocation density of the semiconductor thin films 12 and 17 affects the difference between the crystal structure and lattice constant of the semiconductor thin films 12 and 17 and the crystal structure and lattice constant of the substrates. When the dislocation densities of the semiconductor thin films 12 and 17 are significantly different from those of the substrates, many dislocations occur in the semiconductor thin films 12 and 17. On the other hand, when the dislocation densities of the semiconductor thin films 12 and 17 are closer to those of the substrates, the occurrence of dislocations in the semiconductor thin films 12 and 17 decreases.

Comparing the generated amounts of oxygen and hydrogen in Example 1 and Comparative Examples 1 and 4, there was no significant difference in the generated amounts immediately after light irradiation, but there was a difference in the generated amounts as time passed from the start of light irradiation. It was found that in Comparative Examples 1 and 4, the generated amount of hydrogen decreased by about 50% after 50 hours from light irradiation, while in Example 1, the generated amount of hydrogen was maintained at about 10% decrease after 50 hours from light irradiation. After 100 hours from light irradiation, the generated amount of hydrogen in Example 1 decreased by 20%, while in Comparative Examples 1 and 4, the generated amount of hydrogen decreased by 90% and the generated amount of oxygen decreased by 95%. In Comparative Examples, in addition to a significant decrease in the generated amount of hydrogen, the ratio of the generated amount of oxygen to that of hydrogen was no longer 1:2, which is thought to have resulted in a significant increase in hydrogen production due to side reactions (etching reactions) on the semiconductor electrode surface. These events were the same in the case where Example 2 was compared with Comparative Examples 2 and 5, and the case where Example 3 was compared with Comparable Examples 3 and 6. This may be due to that the semiconductor photocatalyst was grown on the substrates with the same element and crystal structure, and the dislocation density was reduced, which reduces the etching reaction at the dislocation origin, and the water splitting reaction was extended.

Comparing the generated amounts of oxygen and hydrogen in Example 4 and Comparative Examples 7 and 9, there was no significant difference in the generated amounts immediately after light irradiation, but there was a difference in the generated amounts as time passed from the start of light irradiation. It was found that the generated amount of hydrogen in Comparative Examples 7 and 9 each decreased by about 30% and about 50% after 50 hours from light irradiation, while in Example 4, the generated amount of hydrogen was maintained at about 15% decrease after 50 hours from light irradiation. After 100 hours from light irradiation, the generated amount of hydrogen in Example 4 decreased by 20%, while the generated amount of hydrogen in Comparative Examples 7 and 9 each decreased by about 90% and about 90%, and the generated amount of oxygen decreased by about 70% and about 95%, respectively. In Comparative Examples, in addition to a significant decrease in the generated amount of hydrogen, the ratio of the generated amount of oxygen to that of hydrogen was no longer 1:2, which is thought to have resulted in a significant increase in hydrogen production due to side reactions (etching reactions) on the semiconductor electrode surface. These events were the same when Example 5 was compared with Comparative Examples 8 and 10. This may be due to that the semiconductor photocatalyst was grown on the substrates with the same element, and the dislocation density was reduced, which reduces the etching reaction at the dislocation origin, and the water splitting reaction was extended.

In addition, more gas generation was detected in Examples 2, 4, and 3, 5 than in Example 1. This is because the InGaN used in Examples 2 and 4 has a narrower band gap than GaN, which widens the wavelength range that can be absorbed and improves the optical absorption rate. In addition, the AlGaN used in Examples 3 and 5 has a smaller lattice constant than GaN, and the large electric field generated in AlGaN by the piezoelectric effect promotes the separation of electrons and holes, resulting in improved quantum yield.

Comparing the generated amounts of oxygen and hydrogen in Example 1 and Comparative Examples 11 and 12, although there was no great difference in the generated amounts immediately after the light irradiation, a difference was observed in the generated amounts as time passed from the start of the light irradiation. The reason for this is that when no protective layer is formed as in Comparative Examples, side reactions (etching reactions) proceeded on the back surface of the substrate in contact with the aqueous solution and on the side surfaces of the semiconductor.

From the above, the use of a semiconductor photocatalytic thin film with a reduced dislocation density using an n-GaN or GaN substrate prolonged the generation of hydrogen and oxygen (solar energy conversion efficiency) by water splitting reaction.

As described above, the nitride semiconductor photocatalytic thin film 1 of the present embodiment is a nitride semiconductor photocatalytic thin film 1 that exhibits a catalytic function to cause a redox reaction by light irradiation. The nitride semiconductor photocatalytic thin film 1 includes a conductive substrate 11; a semiconductor thin film 12 disposed on a surface of the substrate 11; a first catalyst layer 13 that forms an ohmic junction on a portion of a surface of the semiconductor thin film 12; a second catalyst layer 14 that forms a Schottky junction on a portion of the surface of the semiconductor thin film 12, and a protective layer 15 disposed to cover a back surface of the substrate 11 and side surfaces of the substrate 11 and the semiconductor thin film 12. The substrate 11 and the semiconductor thin film 12 include a same element and have a same crystal structure.

When a gallium nitride thin film is irradiated with light in an aqueous solution, the etching reaction of GaN proceeds on the gallium nitride surface as a side reaction in addition to the desired water oxidation reaction. This etching reaction tends to proceed at the dislocation lines (lattice defects) exposed on the gallium nitride surface. These dislocation lines are generated from the step of producing a gallium nitride thin film, and the higher the dislocation density in the material, the more dislocation lines are exposed and the easier it is for the etching reaction to proceed. The nitride semiconductor photocatalytic thin film 1 of the present embodiment includes the substrate 11 and the semiconductor thin film 12 having a similar crystal structure and lattice constant, and the dislocation density in the semiconductor thin film 12 after deposition can be reduced. Therefore, the degradation reaction (etching) of the semiconductor thin film 12 that progresses from dislocation lines (lattice defects) is reduced, and the solar energy conversion efficiency of the nitride semiconductor photocatalytic thin film can be extended.

By changing the metal on the surface of the first catalyst layer 13 to, for example, Ni, Fe, Au, Pt, Ag, Cu, In, Ti, Co, or Ru, or by changing the atmosphere in the cell, it is also possible to produce carbon compounds by carbon dioxide reduction reaction and ammonia by nitrogen reduction reaction.

REFERENCE SIGNS LIST

| | |
|---|---|
| 1 | Nitride semiconductor photocatalytic thin film |
| 11, 16 | Substrate |
| 12, 17 | Semiconductor thin film |
| 13 | First catalyst layer |
| 14 | Second catalyst layer |
| 15 | Protective layer |

1. A nitride semiconductor photocatalytic thin film that exhibits a catalytic function to cause a redox reaction by light irradiation, the nitride semiconductor photocatalytic thin film comprising:
a conductive substrate;
a semiconductor thin film placed on a surface of the conductive substrate;
a first catalyst layer configured to form an ohmic junction on a portion of a surface of the semiconductor thin film;
a second catalyst layer configured to form a Schottky junction on a portion of the surface of the semiconductor thin film, and
a protective layer placed to cover a back surface of the conductive substrate and a plurality of side surfaces of the conductive substrate and the semiconductor thin film,
wherein the conductive substrate and the semiconductor thin film include a same element and have a same crystal structure.

2. The nitride semiconductor photocatalytic thin film according to claim 1, wherein the conductive substrate is an n-type semiconductor.

3. A nitride semiconductor photocatalytic thin film that exhibits a catalytic function to cause a redox reaction by light irradiation, the nitride semiconductor photocatalytic thin film comprising:
an insulative substrate;
an n-type semiconductor thin film placed on a surface of the insulative substrate;
a semiconductor thin film placed on a surface of the n-type semiconductor thin film;
a first catalyst layer configured to form an ohmic junction on a portion of a surface of the semiconductor thin film;
a second catalyst layer configured to form a Schottky junction on a portion of the surface of the semiconductor thin film, and
a protective layer disposed to cover a back surface of the insulative substrate and a plurality of side surfaces of the insulative substrate and the semiconductor thin film,
wherein the insulative substrate, the n-type semiconductor thin film, and the semiconductor thin film include a same element and have a same crystal structure.

4. A method for producing a nitride semiconductor photocatalytic thin film that exhibits a catalytic function to cause a redox reaction by light irradiation, the method comprising:
forming a semiconductor thin film on a surface of a conductive substrate;
forming a first catalyst layer on a portion of a surface of the semiconductor thin film;
performing heat treatment to form an ohmic junction between the semiconductor thin film and the first catalyst layer;
forming a second catalyst layer on a portion of the surface of the semiconductor thin film;
performing heat treatment on the second catalyst layer; and
forming a protective layer to cover a back surface of the conductive substrate and a plurality of side surfaces of the conductive substrate and the semiconductor thin film,
wherein the conductive substrate and the semiconductor thin film include a same element and have a same crystal structure.

5. The method for producing a nitride semiconductor photocatalytic thin film according to claim 4,
wherein a metal organic chemical vapor deposition method is used in the forming of the semiconductor thin film.

6. (canceled)

7. (canceled)
